(19) United States
(12) Patent Application Publication
(10) Pub. No.: US 2013/0174932 A1
(43) Pub. Date: Jul. 11, 2013

(54) Outlet Pipe Structure of a Faucet

(71) Applicant: Globe Union Industrial Corp., Taichung City (TW)

(72) Inventor: Hsien-Chang Hou, Taichung City (TW)

(73) Assignee: Globe Union Industrial Corp., Taichung City (TW)

(21) Appl. No.: 13/779,837

(22) Filed: Feb. 28, 2013

(30) Foreign Application Priority Data
Mar. 1, 2010 (CN) 201220073666.6

(51) Int. Cl. F16L 9/19

(52) U.S. Cl. CPC F16L 9/19
USPC 138/114

(57) ABSTRACT

An outlet pipe structure of a faucet contains an inner pipe, an inlet connector, an outlet connector, a filler, and an outer pipe. The inner pipe includes an inlet segment, an outlet segment, and an inner channel. The inlet connector is preformed from metal material and welded on the inlet segment and includes a first projected rib and an inlet communicating with the inner channel. The outlet connector is preformed from metal material and welded on the outlet segment and includes a second projected rib. The filler is molded around the inner pipe and filled between the first projected rib and the second projected rib. The outer pipe is molded around the filler, the inlet connector, and the outlet connector and includes an outlet formed thereon. The outlet communicates with the inner channel of the inner pipe via the outlet connector.

### FIELD OF THE INVENTION

The present invention relates to an outlet pipe structure of a faucet.

### BACKGROUND OF THE INVENTION

Conventional outlet pipe of a faucet is cast molded from copper material, so its production cost is high.

CN Publication No. 201606557U discloses that a composite faucet is comprised of a filler body and a housing, but such a structure is not applied in an outlet pipe of a faucet. However, it is difficult to machine the filler body of the composite faucet so as to form an inlet, an outlet, and a channel. Also, the machining cost is high.

In addition, the channel has a channel tube inserted therein, but it cannot be embodied. Due to a flexible pipe or a plastic pipe is flexible, two ends of the flexible pipe or the plastic pipe cannot connect with the inlet and the outlet, thus leaking water and dropping easily. If the copper pipe or an aluminum pipe is used as the outlet pipe of the faucet, it is easy to be fixed, yet its flexibility is too poor to insert into a curved channel. Likewise, an opening of the filler body screws with a threaded connector, but the filler body is made of cements, calcium carbonates or gypsums, so the threaded connector looses easily, thus leaking water.

The present invention has arisen to mitigate and/or obviate the afore-described disadvantages.

### SUMMARY OF THE INVENTION

The primary object of the present invention is to provide an outlet pipe structure of a faucet which is capable of overcoming the shortcomings of the conventional outlet pipe structure of the faucet.

To obtain the above objectives, an outlet pipe structure of a faucet provided by the present invention contains: an inner pipe, an inlet connector, an outlet connector, a filler, and an outer pipe.

The inner pipe includes an inlet segment, an outlet segment, and an inner channel. The inlet connector is preformed from metal material and welded on the inlet segment and includes a first projected rib and an inlet communicating with the inner channel. The outlet connector is preformed from metal material and welded on the outlet segment and includes a second projected rib. The filler is molded around the inner pipe and filled between the first projected rib and the second projected rib. The outer pipe is molded around the filler, the inlet connector, and the outlet connector and includes an outlet formed thereon. The outlet communicates with the inner channel of the inner pipe via the outlet connector.

Thereby, the outlet pipe structure of the present invention contains the filler comprised of resin sand and curing agent or quartz sands and curing agent so that the filler is used as a body of the outlet pipe, and zinc alloy material is made into a housing of the outlet pipe, thus lowering copper material consumption and production cost.

The inner pipe includes the inner channel directly formed therein, so the inner channel is not extra machined in the inner pipe, thereby avoiding machining cost. The filler is molded around the inner pipe and is filled among the first projected rib of the inlet connector, the second projected rib of the outlet connector, and the outer pipe, thus enhancing structural stability of the outlet pipe structure.

Also, the inlet is formed from the inlet connector made of metal material, and the outlet is formed from the outer pipe, thus increasing structural stability of the outlet pipe structure as well.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross sectional view showing the assembly of a part of an outlet pipe structure of a faucet according to a preferred embodiment of the present invention.

FIG. 2 is a partial cross sectional view showing an inlet connector and an outlet connector being welded on two ends of an inner pipe of the outlet pipe structure of the faucet according to the preferred embodiment of the present invention.

FIG. 3 is a partial cross sectional view showing a filler filled between a first projected rib of the inlet connector and a second projected rib of the outlet connector.

FIG. 4 is a partial cross sectional showing a first clamping portion of the inlet connector and a second clamping portion of the outlet connector being cut.

### DETAILED DESCRIPTION OF THE PREFERRED EMBODIMENTS

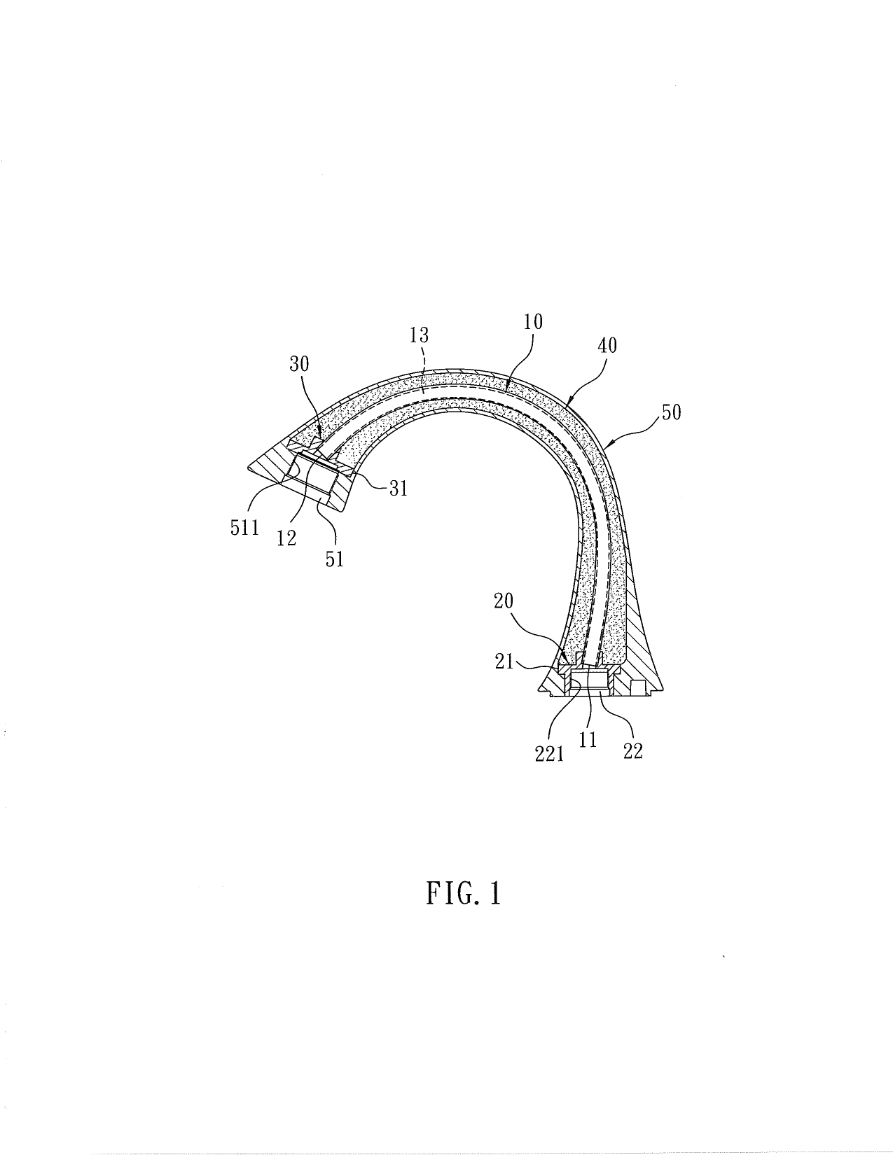

Referring further to FIG. 1, an outlet pipe structure of a faucet according to a preferred embodiment of the present invention comprises: an inner pipe 10 made of copper material, an inlet connector 20, an outlet connector 30, a filler 40, and an outer pipe 50 made of metal materials.

The inner pipe 10 includes an inlet segment 11, an outlet segment 12, and an inner channel 13.

The inlet connector 20 is preformed from metal material and is welded on the inlet segment 11 of the inner pipe 10, and the inlet connector 20 includes a first projected rib 21 arranged therearound and an inlet 22, the inlet 22 has inner threads 221 molded therein.

The outlet connector 30 is preformed from metal material and is welded on the outlet segment 12 of the inner pipe 10, and the outlet connector 30 includes a second projected rib 31 arranged therearound.

The filler 40 is molded around the inner pipe 10 and is filled between the first projected rib 21 of the inlet connector 20 and the second projected rib 31 of the outlet connector 30. The filler 40 is comprised of resin sand and curing agent or is comprised of quartz sands and curing agent.

The outer pipe 50 is molded around the filler 40, the inlet connector 20, and the outlet connector 30, and the outer pipe 50 includes an outlet 51 formed thereon. The outlet 51 communicates with the inner channel 13 of the inner pipe 10 via the outlet connector 30 and has internal threads 511 formed therein, and the outer pipe 50 includes an electroplating layer (not shown) formed around an outer surface thereof.

A process for making the outlet pipe structure of the faucet contains steps of:

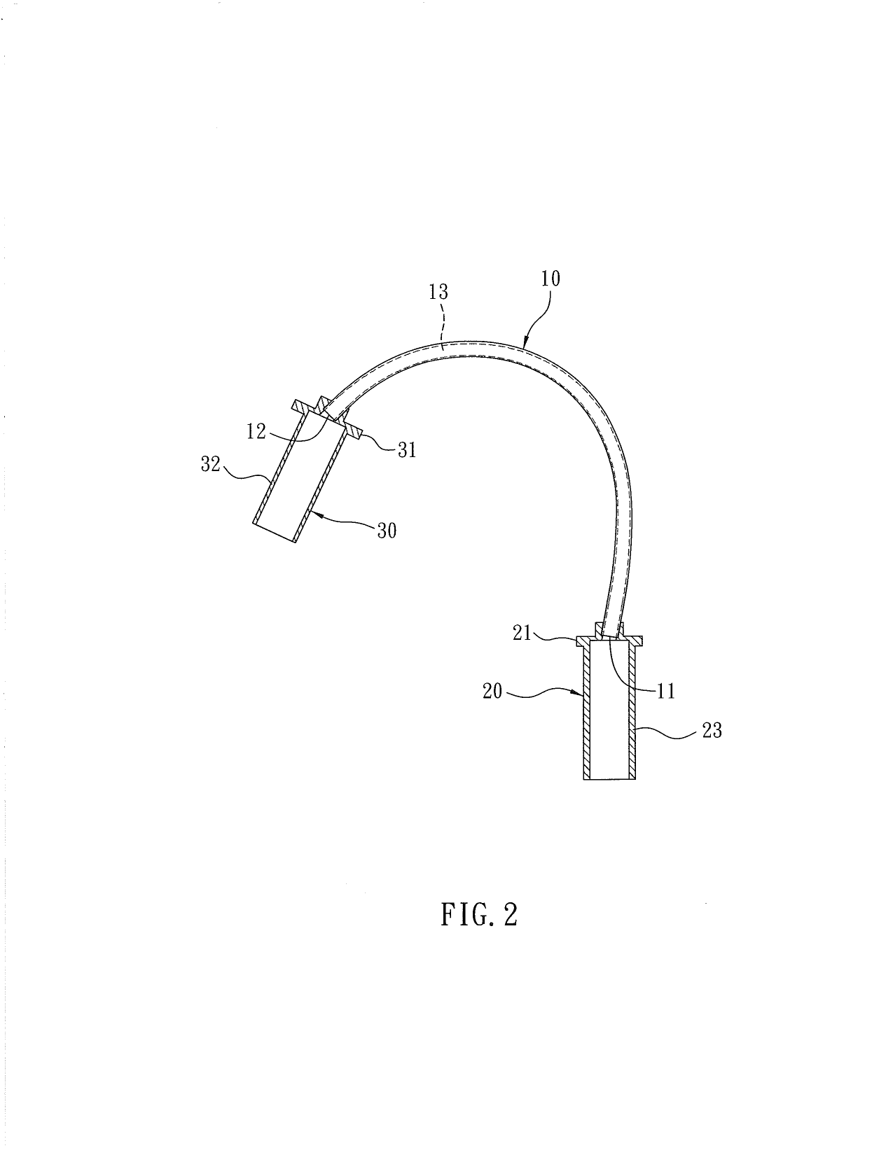

a. cutting a copper pipe at a predetermined length and bending the copper pipe to form the inner pipe 10 as shown in FIG. 2.

b. welding the inlet connector 20 and the outlet connector 30 on two ends of the inner pipe 10.

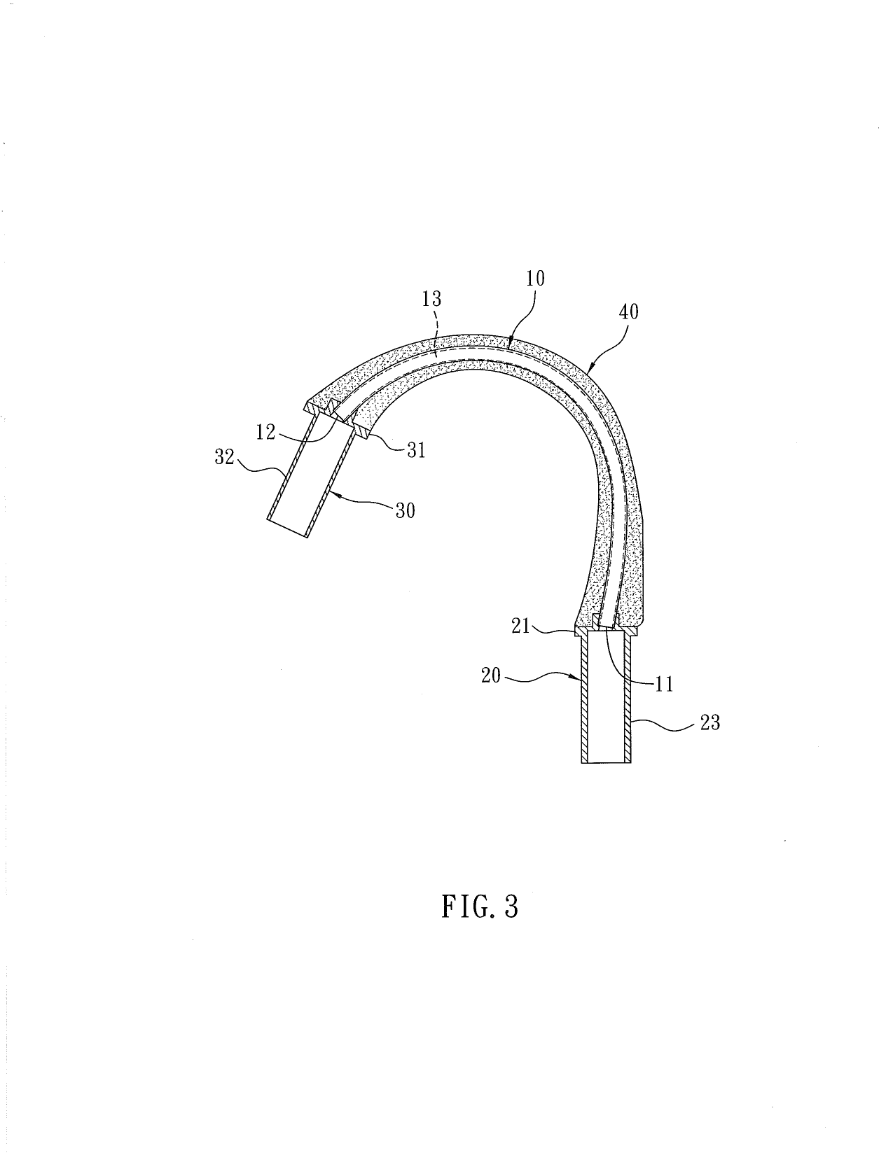

c. placing the inner pipe 10, the inlet connector 20 and the outlet connector 30 of the two ends of the inner pipe 10 into a mold so as to cast the inner pipe 10, the inlet connector 20, and the outlet connector 30, such that the filler 40 is molded around the inner pipe 10 and is filled between the inlet connector 20 and the outlet connector 30 as illustrated in FIG. 3, wherein the inlet connector 20 includes the first projected rib 21 arranged therearound, and the outlet connector 30 includes the second projected rib 31 arranged therearound so as to prevent the filler 40 from leakage.

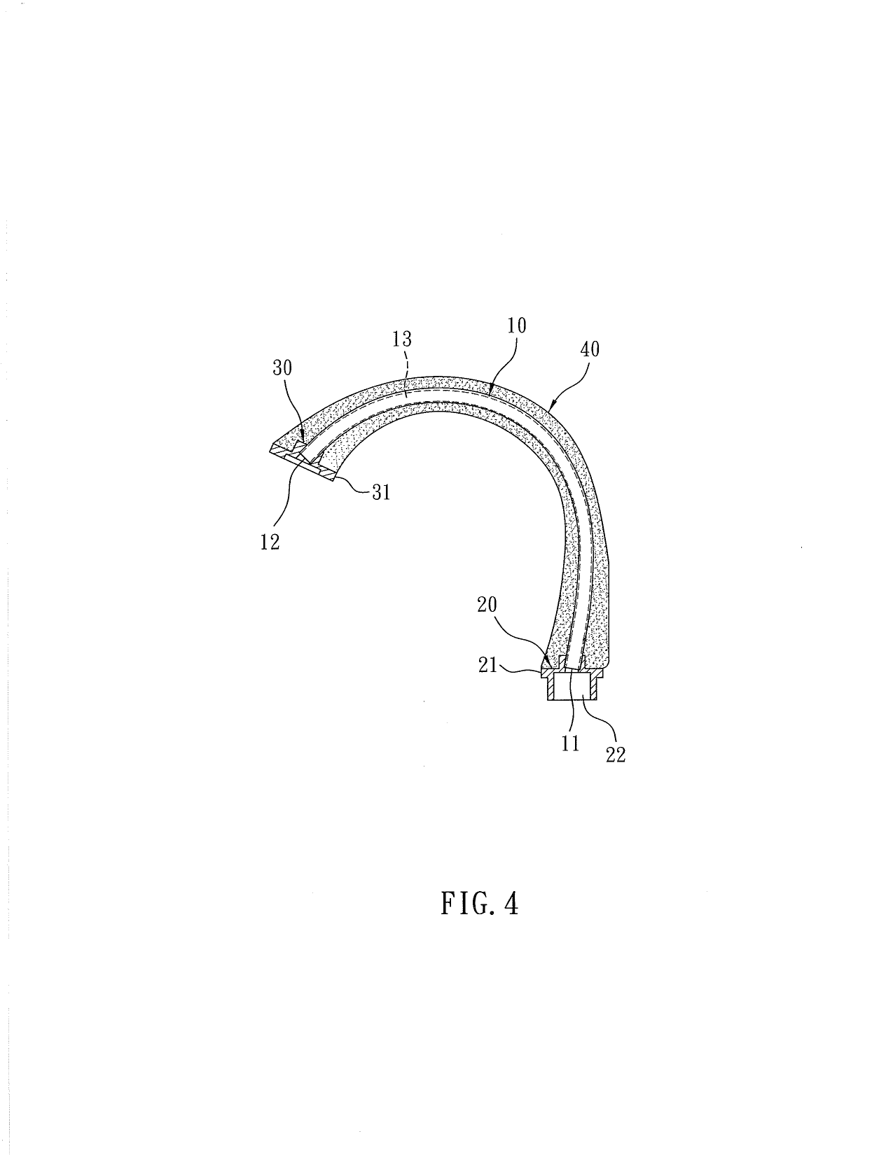

d. cutting a first clamping portion 23 of the inlet connector 20 and a second clamping portion 32 of the outlet connector 30 as shown in FIG. 4, wherein the first clamping portion 23 and the second clamping portion 32 are arranged to clamp the inlet connector 20 and the outlet connector 30 in a welding process.

e. placing the inner pipe 10, the inlet connector 20, the outlet connector 30, and the filler 40 into a zinc die casting mold so as to have a zinc coating process, thus obtaining the outer pipe 50 made of metal materials.

f. machining an interior of the inlet 22 of the inlet connector 20 and an interior of the outlet 51 of the outer pipe 50 so as to form the inner threads 221 and the internal threads 551 as shown in FIG. 1 such that the outer pipe screws with a faucet aerator or a water supply assembly, thereafter polishing and electroplating the outer surface of the outer pipe 50 so as to finish the outlet pipe.

Thereby, the outlet pipe structure of the present invention contains the filler 40 comprised of resin sand and curing agent or quartz sands and curing agent so that the filler 40 is used as a body of the outlet pipe, and zinc alloy material is made into a housing of the outlet pipe, thus lowering copper material consumption and production cost.

The inner pipe 10 includes the inner channel 13 directly formed therein, so the inner channel 13 is not extra machined in the inner pipe 10, thereby avoiding machining cost. The filler 40 is molded around the inner pipe 10 and is filled among the first projected rib 21 of the inlet connector 20, the second projected rib 31 of the outlet connector 30, and the outer pipe 50, thus enhancing structural stability of the outlet pipe structure. Also, the inlet 22 is formed from the inlet connector 30 made of metal material, and the outlet 51 is formed from the outer pipe 50, thus increasing structural stability of the outlet pipe structure as well.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An outlet pipe structure of a faucet comprising:
an inner pipe including an inlet segment, an outlet segment, and an inner channel;
an inlet connector preformed from metal material and welded on the inlet segment of the inner pipe, and the inlet connector including a first projected rib arranged therearound and an inlet; the inlet communicating with the inner channel of the inner pipe;
an outlet connector preformed from metal material and welded on the outlet segment of the inner pipe, and the outlet connector including a second projected rib arranged therearound;
a filler molded around the inner pipe and filled between the first projected rib of the inlet connector and the second projected rib of the outlet connector;
an outer pipe molded around the filler, the inlet connector, and the outlet connector and including an outlet formed thereon; the outlet communicating with the inner channel of the inner pipe via the outlet connector.

2. The outlet pipe structure of the faucet as claimed in claim 1, wherein the filler is comprised of resin sand and curing agent or is comprised of quartz sands and curing agent.

3. The outlet pipe structure of the faucet as claimed in claim 1, wherein the outer pipe is made of zinc alloy material.

4. The outlet pipe structure of the faucet as claimed in claim 1, wherein the inlet of the inlet connector has inner threads molded therein

5. The outlet pipe structure of the faucet as claimed in claim 1, wherein the outlet of the outlet pipe has internal threads formed therein.

6. The outlet pipe structure of the faucet s as claimed in claim 1, wherein the outer pipe includes an electroplating layer formed around an outer surface thereof.
